(19) United States
(12) Patent Application Publication
(10) Pub. No.: US 2011/0084025 A1
(43) Pub. Date: Apr. 14, 2011

(54) WATER PURIFIER AND WATER PURIFICATION METHOD

(75) Inventors: Jo Tominaga, Ashigarakami-gun (JP); Morihito Ikeda, Ashigarakami-gun (JP); Fumio Mogi, Ashigarakami-gun (JP); Kimiaki Miyamoto, Ashigarakami-gun (JP)

(73) Assignee: FUJIFILM Corporation, Tokyo (JP)

(21) Appl. No.: 12/897,441

(22) Filed: Oct. 4, 2010

(30) Foreign Application Priority Data
Oct. 5, 2009 (JP) 2009-231770

(51) Int. Cl. C02F 1/04; C02F 1/42; B01D 3/34; B01D 61/00

(52) U.S. Cl. 210/638; 210/177

(57) ABSTRACT

To provide a water purifier containing: a diluting unit configured to bring targeted water into contact with a nonvolatile compound-containing aqueous solution via a semi-permeable membrane to separate water from the targeted water by the membrane, and to dilute the nonvolatile compound-containing aqueous solution with the separated water; a separating unit configured to heat the diluted aqueous solution so as to separate water vapor from the diluted aqueous solution, and to obtain the concentrated aqueous solution; a condensing unit configured to cool the separated water vapor to generate water; an evaporating unit configured to collect, as purified water, part of the generated water, and to evaporate the rest of the generated water under the reduced pressure to obtain water vapor; and an absorbing unit configured to allow the concentrated aqueous solution obtained by the separating unit to absorb the water vapor obtained by the evaporating unit.

### BACKGROUND OF THE INVENTION

1. Field of the Invention

The present invention relates to a water purifier capable of reducing inner pressure thereof without any special power, capable of efficiently providing highly purified water, and having excellent cooling effects. The present invention also relates to a water purification method using the same.

2. Description of the Related Art

A reverse osmosis (RO) process using external pressure and a forward osmosis (FO) process have been known as a method for selectively separating and transferring water between two solutions having mutually different osmotic pressures.

One example of the forward osmosis processes is a method using a volatile ion-containing solution including volatile anions and volatile cations. For example, in US Patent Application Publication No. 2005/0145568, there has been proposed a water purifying device containing: a diluting unit 12 configured to bring targeted water into contact with a volatile ion-containing solution including volatile anions and volatile cations via a semi-permeable membrane 11, and to dilute the volatile ion-containing solution with water separated from the targeted water by the semi-permeable membrane 11; a separating unit 15 containing a distillation column 17 configured to make the volatile anions and the volatile cations volatilize from the diluted volatile ion-containing solution by the diluting unit; and a dissolving unit 14 containing a gas absorbing unit 16 configured to return and dissolve the vaporized anion and cation gases separated by the separating unit 15 to and in the diluted volatile ion-containing solution, as shown in FIG. 1.

The water purification device of this proposal collects purified water by separating the volatile ions by the separating unit, after taking the separated water from the targeted water in by the diluting unit. Hence, there is a possibility that the purified water may be contaminated by the residual volatile ions, which has not been completely separated.

In addition, a so-called absorption cooling system has been proposed, and the absorption cooling system can provide a low temperature condition by making a solution containing a solute having high absorption of water, such as LiBr, absorb water vapor, and vaporizing the collected water under low pressure (see Japanese Patent (JP-B) No. 3475003, and Journal of the Japan Society of Mechanical Engineers (B edition) vol. 67 no. 658 (2001-6) 178-184.

The absorption cooling system may be of single-effect or of multiple-effect. For example, the absorption cooling system contains, as shown in FIG. 2, a separating unit 2, a condensing unit 3, an evaporating unit 4, and absorbing unit 5, and may further contain other units, if necessary.

The separating unit 2 applies thermal energy to the nonvolatile compound (LiBr) solution which has been diluted by absorbing the water vapor, so as to evaporate water from the solution. As a result, the diluted nonvolatile compound (LiBr) solution is separated into water vapor and the concentrated LiBr solution.

Next, the condensing unit 3 cools the water vapor separated by the separating unit 2, to thereby generate water.

The water generated by the condensing unit 3 is then compressed by a pressure reducing valve 8, and then evaporated by an evaporating unit 4 which is in a highly vacuumed state. In the course of the evaporation of the water, vaporization heat is generated, which is used for cooling a refrigerant present in a pipe. Using the cooled refrigerant circulated in the pipe, a room or the like is cooled (i.e. air-conditioned) by an air conditioner 7.

The water vapor obtained by the evaporating unit 4 is absorbed in the LiBr solution by an absorbing unit 5. As a result of this, the highly vacuumed state of the evaporating unit 4 is maintained. When the LiBr solution absorbs the water vapor, heat is generated so that the absorbing unit 5 is cooled.

Next, the diluted LiBr solution is sent to the separating unit 2 by a feeding pump (not shown in FIG. 2), and recycled. By repeating the cycle described above, the cooled refrigerant (e.g. water) can be continuously supplied. In FIG. 2, “6” denotes a pipe, and “9” denotes a pressure reducing valve.

The absorption cooling system has an excellent cooling effect. However, the entire water in the system needs to be circulated, and there is no intention to collect purified water.

### BRIEF SUMMARY OF THE INVENTION

The present invention aims at providing a water purifier capable of reducing inner pressure thereof without any special power, capable of efficiently providing highly purified water, and having excellent cooling effects, as well as providing a water purification method using the same.

Means for solving the aforementioned problems are as follows:

<1> A water purifier containing:

a diluting unit configured to bring targeted water for purification into contact with a nonvolatile compound-containing aqueous solution via a semi-permeable membrane so as to separate water from the targeted water by the semi-permeable membrane, and to dilute the nonvolatile compound-containing aqueous solution with the separated water;

a separating unit configured to heat the diluted nonvolatile compound-containing aqueous solution so as to separate water vapor from the diluted nonvolatile compound-containing aqueous solution, and to obtain the concentrated nonvolatile compound-containing aqueous solution;

a condensing unit configured to cool the separated water vapor so as to generate water;

an evaporating unit configured to collect, as purified water, part of the water generated by the condensing unit, and to evaporate the rest of the water under the reduced pressure so as to obtain water vapor; and

an absorbing unit configured to allow the concentrated nonvolatile compound-containing aqueous solution obtained by the separating unit to absorb the water vapor obtained by the evaporating unit.

The water purifier according to <1> contains the diluting unit, the separating unit, the condensing unit, the evaporating unit, and the absorbing unit.

The diluting unit is configured to bring the targeted water into contact with the nonvolatile compound-containing aqueous solution via the semi-permeable membrane to separate water from the targeted water by the semi-permeable membrane, and to dilute the nonvolatile compound-containing aqueous solution with the separated water.

The separating unit is configured to heat the diluted nonvolatile compound-containing aqueous solution to separate waver vapor from the diluted nonvolatile compound-containing aqueous solution, to thereby obtain the concentrated nonvolatile compound-containing aqueous solution.

The condensing unit is configured to cool the separated water vapor to generate water.

The evaporating unit is configured to collect part of the water generated by the condensing unit as purified water, and to evaporate the rest of the water under the reduced pressure to obtain water vapor.

The absorbing unit is configured to allow the concentrated nonvolatile compound-containing aqueous solution obtained by the separating unit to absorb the water vapor obtained by the evaporating unit. As a result, the inner atmosphere of the system can be kept in the reduced pressure without using any special power, and highly purified water can be efficiently obtained.

<2> The water purifier according to <1>, wherein the diluting unit is disposed between the separating unit and the absorbing unit, and the nonvolatile compound-containing aqueous solution is circulated between the separating unit and the absorbing unit with a concentration thereof changing.

In the water purifier according to <2>, the diluting unit is disposed between the separating unit and the absorbing unit. Therefore, highly purified water can be obtained.

Moreover, as the nonvolatile compound-containing aqueous solution is circulated between the separating unit and the absorbing unit with its concentration changing, highly purified water can very efficiently obtained.

<3> The water purifier according to <1>, wherein the nonvolatile compound is a compound capable of absorbing water.

In the water purifier according to <3>, as the nonvolatile compound is the compound capable of absorbing water, the inner atmosphere of the system can be kept in the reduced pressure by absorbing the water vapor obtained in the evaporating unit with the nonvolatile compound.

<4> The water purifier according to <1>, wherein the nonvolatile compound is a water-soluble compound.

In the water purifier according to <4>, as the nonvolatile compound is the water-soluble compound, high osmotic pressure can be applied by passing through the semi-permeable membrane so that the nonvolatile compound can absorb water from the targeted water, which contributes the collection of purified water.

<5> The water purifier according to <1>, wherein the nonvolatile compound is LiBr.

In the water purifier according to <5>, the nonvolatile compound is LiBr. Since LiBr is nonvolatile, water soluble, and can absorbs water, it is suitable for a solute.

<6> The water purifier according to <1>, wherein the evaporating unit contains a cooling pipe in which a refrigerant is contained and circulated, and

wherein the refrigerant within the cooling pipe is cooled by vaporization heat generated at the time when the water is evaporated in the evaporating unit, and the cooled refrigerant is used for air-conditioning.

In the water purifier according to <6>, the evaporating unit contains the cooling pipe, in which the refrigerant is circulated, and the refrigerant within the cooling pipe is cooled by vaporization heat generated at the time when the water is evaporated in the evaporating unit. Therefore, air conditioning can be performed for cooling the air using the cooled refrigerant, and in such manner, a conventional absorption cooling system can be effectively used.

<7> The water purifier according to <1>, wherein the evaporating unit, the absorbing unit, and a passage between the evaporating unit and the absorbing unit are all controlled to have the reduced pressure of 1 kPa or lower.

<8> The water purifier according to <1>, wherein the separating unit, the condensing unit, and a passage between the separating unit and the condensing unit are all controlled to have the reduced pressure of 5 kPa to 10 kPa.

<9> The water purifier according to <1>, wherein the semi-permeable membrane is a forward osmosis semi-permeable membrane which selectively passes water through.

<10> The water purifier according to <1>, wherein the targeted water for purification is sea-water.

<11> A water purification method, containing:

bringing targeted water for purification into contact with a nonvolatile compound-containing aqueous solution via a semi-permeable membrane so as to separate water from the targeted water by the semi-permeable membrane, and diluting the nonvolatile compound-containing aqueous solution with the separated water;

heating the diluted nonvolatile compound-containing aqueous solution so as to separate water vapor from the diluted nonvolatile compound-containing aqueous solution and to obtain the concentrated nonvolatile compound-containing aqueous solution;

cooling the separated water vapor so as to generate water;

collecting part of the generated water as purified water, and evaporating the rest of the generated water under the reduced pressure so as to obtain water vapor; and

allowing the concentrated nonvolatile compound-containing aqueous solution to absorb the obtained water vapor.

The water purification method according to <11> contains a diluting step, a separating step, a condensing step, an evaporating step, and an absorbing step.

The diluting step is bringing the targeted water into contact with the nonvolatile compound-containing aqueous solution via the semi-permeable membrane so as to separate water from the targeted water by the semi-permeable membrane, and diluting the nonvolatile compound-containing aqueous solution with the separated water.

The separating step is heating the diluted nonvolatile compound-containing aqueous solution so as to separate water vapor from the diluted nonvolatile compound-containing aqueous solution and to obtain the concentrated nonvolatile compound-containing aqueous solution.

The condensing step is cooling the separated water vapor so as to generate water.

The evaporating step is collecting part of the generated water in the condensing step as purified water, and evaporating rest of the water under the reduced pressure to obtain water vapor.

The absorbing step is allowing the concentrated nonvolatile compound-containing aqueous solution to absorb the obtained water vapor. As a result, the inner atmosphere of the system can be kept in the reduced pressure without using any special power, and highly purified water can be efficiently obtained.

The present invention solves the various problems in the art, and can provide a water purifier capable of reducing inner pressure thereof without any special power, capable of efficiently providing highly purified water, and having excellent cooling effects, as well as providing a water purification method using the same.

### BRIEF DESCRIPTION OF THE DRAWINGS

FIG. 1 is a schematic diagram showing one example of a conventional forward osmosis water purifying device.

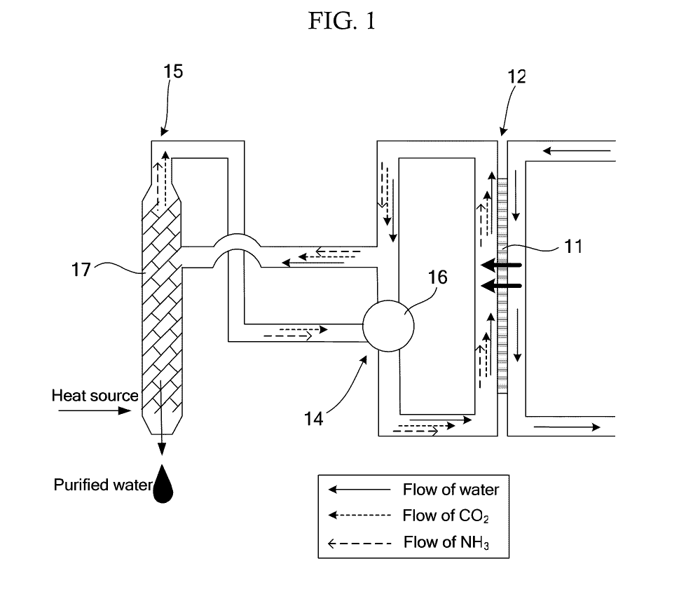

FIG. 2 is a schematic diagram showing one example of a conventional absorption cooling system.

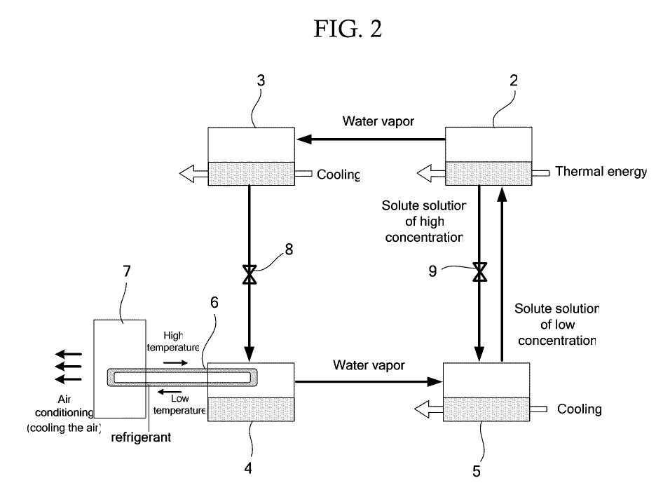

FIG. 3 is a schematic diagram showing one example of the water purifier of the present invention.

### DETAILED DESCRIPTION OF THE INVENTION

### Water Purifier and Water Purification Method

The water purifier of the present invention contains a diluting unit, a separating unit, a condensing unit, an evaporating unit, and an absorbing unit, and may further contain other units, if necessary.

The water purification method of the present invention contains a diluting step, a separating step, a condensing step, an evaporating step, and an absorbing step, and may further contain other steps, if necessary.

The water purification method of the present invention is suitably performed by means of the water purifier of the present invention, the diluting step can be carried out by the diluting unit, the separating step can be carried out by the separating unit, the condensing step can be carried out by the condensing unit, the evaporating step can be carried out by the evaporating unit, the absorbing step can be carried out by the absorbing unit, and the other steps can be carried out by the other units.

<Diluting Unit and Diluting Step>

The diluting step is bringing targeted water for purification into contact with a nonvolatile compound-containing aqueous solution via a semi-permeable membrane so as to separate water from the targeted water by the semi-permeable membrane, and diluting the nonvolatile compound-containing aqueous solution with the water separated from the targeted water. The diluting step can be carried out by the diluting unit.

The diluting unit is suitably selected depending on the intended purpose without any restriction. Examples thereof include a water purifier having a semi-permeable membrane.

The diluting unit may be provided at a location on the passage from the separating unit to the absorbing unit, or on the passage from the absorbing unit to the separating unit. However, it is preferred that the diluting unit be provided at a location on the passage from the separating unit to the absorbing unit, because the solution having a high concentration of a nonvolatile compound can be used, and water vapor is highly efficiently absorbed in the absorbing unit.

—Targeted Water—

The targeted water is suitably selected depending on the intended purpose without any restriction. Examples thereof include sea-water, river water, underground water, industrial effluent, household effluent, and sewage. Among them, sea-water is preferable because a large amount thereof is present, and a purification process can be performed in a large amount thereof.

In the present invention, “purified water” means the targeted water for purification from which 90% or more of impurities have been removed.

—Nonvolatile Compound-Containing Aqueous Solution—

The nonvolatile compound-containing aqueous solution is a solution containing a nonvolatile compound. The nonvolatile compound is preferably a compound which is water-soluble, and capable of absorbing water in order to maintain the inner pressure of the system at reduced pressure by applying osmotic pressure or absorbing water vapor obtained by the evaporating unit. Examples of the nonvolatile compound include: halogenated alkali metals such as LiBr, LiCl, NaCl, and NaI; halogenated alkali earth metals such as CaCl₂, and MgCl₂; and saccharides such as glucose and fructose. Among them, LiBr is particularly preferable, as it has high solubility to water, and it will provide the resulting solution with high moisture uptake.

The nonvolatile compound-containing aqueous solution is circulated between the separating unit and the absorbing unit with the concentration thereof changing. The concentration thereof is suitably selected depending on the intended purpose without any restriction, but it is preferably 40% by mass to 70% by mass.

To the nonvolatile compound-containing aqueous solution, an anti-corrosion agent or the like may be added for preventing corrosion of pipes.

—Semi-Permeable Membrane—

The semi-permeable membrane is suitably selected depending on the intended purpose without any restriction on its material, shape, size, structure, and the like. The semi-permeable membrane is preferably a forward osmosis (FO) semi-permeable membrane, which selectively passes water through.

The forward osmosis semi-permeable membrane is suitably selected depending on the intended purpose without any restriction, provided that it is a semi-permeable membrane. Examples of a material of the forward osmosis semi-permeable membrane include cellulose acetate, aromatic polyamide, alkyl polyamide, polyacrylonitrile, and sulfonated polysulfone.

<Separating Unit and Separating Step>

The separating step is heating the diluted nonvolatile compound-containing aqueous solution so as to separate water vapor from the diluted nonvolatile compound-containing aqueous solution to thereby obtain the concentrated nonvolatile compound-containing aqueous solution. The separating step can be carried out by the separating unit.

The concentrated nonvolatile compound-containing aqueous solution is sent to the absorbing unit, and is diluted by absorbing water vapor in the absorbing unit. The diluted nonvolatile compound-containing aqueous solution is again diluted by the diluting unit, and then sent to the separating unit again. Namely, the nonvolatile compound-containing aqueous solution is circulated between the separating unit and the absorbing unit with the concentration thereof changing.

In the separating unit, the amount of the water is increased by the amount of the water separated from the targeted water by the semi-permeable membrane of the diluting unit, and thus this increased amount of water is collected as purified water.

The heating source of the separating unit is suitably selected depending on the intended purpose without any restriction. For example, waste heat from factories, steam heat, solar heat, or condensation heat or heat of dissolution generated in a system may be used as the heating source.

The heating temperature of the nonvolatile compound-containing aqueous solution in the separating unit is preferably 80° C. to 120° C.

The separating unit is suitably selected depending on the intended purpose without any restriction, provided that it enables to separate water vapor from the diluted nonvolatile compound-containing aqueous solution. Examples thereof include a regenerator.

The internal pressure of the separating unit is preferably 5 kPa to 10 kPa.

<Condensing Unit and Condensing Step>

The condensing step is cooling the water separated in the separating step so as to generate water. The condensing step can be carried out by the condensing unit.

The condensing unit is suitably selected depending on the intended purpose without any restriction, provided that it enables to generate water by cooling the separated water vapor. Examples thereof include a condenser.

The internal pressure of the condensing unit is preferably 5 kPa to 10 kPa.

The separating unit, the condensing unit, and a passage between the separating unit and the condensing unit are preferably all kept in the reduced pressure of 5 kPa to 10 kPa for efficient evaporation and efficient condensation, and for providing high water intake rate with low energy.

<Evaporating Unit and Evaporating Step>

The evaporating step is collecting part of the water generated by the condensing step as purified water, and evaporating the rest of the water under the reduced pressure so as to obtain water vapor. The evaporating step can be carried out by the evaporating unit.

The evaporating unit is suitably selected depending on the intended purpose without any restriction, provided that it can collect part of the generated water as purified water, and evaporating the rest of the water under the reduced pressure so as to obtain water vapor. Examples thereof include an evaporator.

The inner pressure of the evaporating unit is preferably 1 kPa or lower.

The evaporating unit contains a cooling pipe in which the refrigerant is circulated. The refrigerant within the cooling pipe is cooled by vaporization heat generated at the time when water is evaporated by the evaporating unit, and the cooled refrigerant can be used for air conditioning.

<Absorbing Unit and Absorbing Step>

The absorbing step is allowing the concentrated nonvolatile compound-containing aqueous solution obtained by the separating unit to absorb the water vapor obtained in the evaporating step. The absorbing step can be carried out by the absorbing unit.

The absorbing unit is suitably selected depending on the intended purpose without any restriction provided that it can absorb the water vapor obtained in the evaporating step. Examples thereof include an absorber.

The inner pressure of the absorbing unit is preferably 1 kPa or lower.

The evaporating unit, the absorbing unit, and the passage between the evaporating unit and the absorbing unit are all kept in the reduced pressure of 1 kPa or lower for efficient evaporation and efficient absorption, and for providing high water intake rate with low energy.

—Other Units and Other Steps—

For other steps, there are, for example, a controlling step, a driving step, and the like, and these can be carried out by a controlling unit, a driving unit, and the like.

The controlling unit is suitably selected depending on the intended purpose without any restriction, provided that it can control each of the aforementioned units. Examples thereof include devices such as a sequencer, a computer, and the like.

The water purification method of the present invention includes bringing targeted water for purification in contact with a nonvolatile compound-containing aqueous solution via a semi-permeable membrane so as to separate water from the targeted water, and diluting the nonvolatile compound-containing aqueous solution with the water separated by the semi-permeable membrane.

Then, the diluted nonvolatile compound-containing aqueous solution is heated so as to separate water vapor from the diluted nonvolatile compound-containing aqueous solution to thereby obtain the concentrated nonvolatile compound-containing aqueous solution.

Thereafter, the separated water vapor is cooled to generate water.

Part of the generated water is collected as purified water, and the rest of the water is evaporated under the reduced pressure to obtain water vapor. At this time, the refrigerant within the cooling pipe is cooled by vaporization heat generated as the water evaporates, and the cooled refrigerant is used for air conditioning (cooling the air).

The obtained water vapor is absorbed with the nonvolatile compound-containing aqueous solution concentrated in the separating step.

Note that, the required amount of the solute can be monitored by measuring electric conductivity at the outlet of the absorbing unit and inlet of the separating unit. Moreover, the amount of the water to be separated by the separating unit can be measured based upon the amount of the absorbed water, and in this manner, the amount of the water to be collected at the outlet of the condensing unit and by the evaporating unit can be measured.

The water purifier and water purification method of the present invention can reduce inner pressure of the water purifier without any special power, can efficiently provide highly purified water, and have excellent cooling effects. Therefore, the present invention can be used for purification of various water using conventional absorption cooling systems, and is especially suitably used for purification of sea-water.

### EXAMPLES

Examples of the present invention will be explained in detail with reference to drawings hereinafter, but these examples shall not be construed as limiting the scope of the present invention.

### Example 1

Example 1 of the present invention will be explained hereinafter.

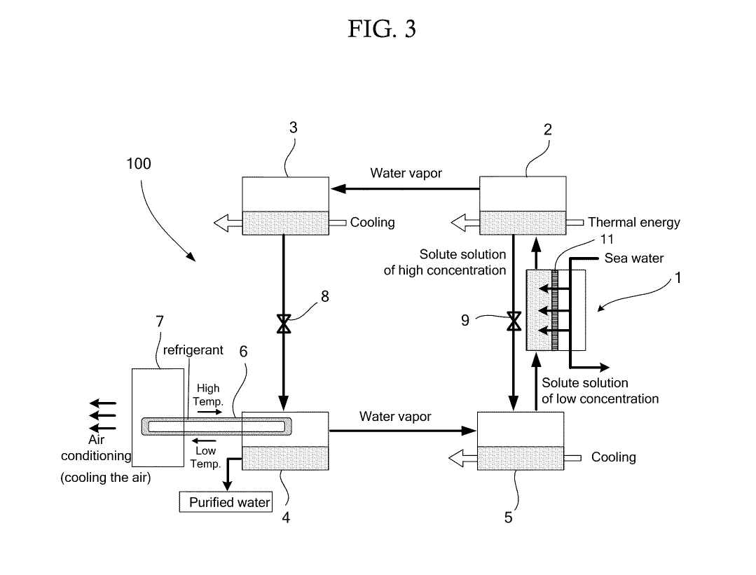

FIG. 3 is a schematic diagram showing Example 1 of the water purifier.

The water purifier 100 of Example 1 contains a diluting unit 1, a separating unit 2, a condensing unit 3, an evaporating unit 4, and an absorbing unit 5.

In this water purifier 100 of Example 1, sea-water is used as targeted water.

The diluting unit 1 is a unit which brings the targeted water into contact with a nonvolatile compound-containing aqueous solution via a semi-permeable membrane 11 to separate water from the targeted water, and dilutes the nonvolatile compound-containing aqueous solution with the water separated from the targeted water by the semi-permeable membrane. The diluting unit 1 is connected to the separating unit 2.

The diluting unit 1 is disposed between the separating unit 2 and the absorbing unit 5.

The diluting unit 1 is constructed so that the nonvolatile compound-containing aqueous solution is circulated between the separating unit 2 and the absorbing unit 5 with the concentration thereof changing.

As the nonvolatile compound, a compound which is water soluble and is capable of absorbing water is used. In Example 1, LiBr is used as the nonvolatile compound.

As the semi-permeable membrane 11, a forward osmosis semi-permeable membrane which selectively passes water through is used. In Example 1, Expedition built-in filter manufactured by Hydration Technology Innovations is used as the forward osmosis semi-permeable membrane.

The separating unit 2 is a unit for heating the nonvolatile compound-containing aqueous solution, which has been diluted by the diluting unit 1, so as to separate water vapor from the diluted nonvolatile compound-containing aqueous solution to thereby obtain the concentrated nonvolatile compound-containing aqueous solution. In Example 1, a regenerator is used as the separating unit 2.

The separating unit 2 is connected to the condensing unit 3, and the inner atmosphere thereof is kept in the reduced pressure of 5 kPa to 10 kPa.

The condensing unit 3 is a unit for cooling the water vapor, which has been separated by the separating unit 2, to generate water. In Example 1, a condenser is used as a condensing unit 3.

The condensing unit 3 is connected to the evaporating unit 4, and the inner atmosphere thereof is kept in the reduced pressure of 5 kPa to 10 kPa.

The evaporating unit 4 is a unit for collecting part of the water generated by the condensing unit 3 as purified water, and evaporating the rest of water under reduced pressure to obtain water vapor. In Example 1, an evaporator is used as the evaporating unit 4.

The evaporating unit 4 is connected to the absorbing unit 5, and the inner atmosphere thereof is kept at 1 kPa or lower.

The evaporating unit 4 is equipped with a cooling pipe 6 in which a refrigerant is circulated, and is configured so that the refrigerant within the cooling pipe is cooled by vaporization heat generated at the time when the water is evaporated in the evaporating unit 4, and the cooled refrigerant is used for air conditioning (cooling air).

The absorbing unit 5 is a unit for allowing the nonvolatile compound-containing aqueous solution, which has been concentrated by the separating unit 2, to absorb the water vapor obtained in the evaporating unit 4. In Example 1, an absorber is used as the absorbing unit 5.

The absorbing unit 5 is connected to the diluting unit 1, and the inner atmosphere thereof is kept at 1 kPa or lower.

In FIG. 3, “7” denotes an air conditioner, “8” and “9” each denote a pressure reducing valve.

Accordingly, in the water purifier of Example 1, the evaporating unit 4, the absorbing unit 5, and the passage between the evaporating unit 4 and the absorbing unit 5 are all kept in the reduced pressure of 1 kPa or lower.

Moreover, in the water purifier of Example 1, the separating unit 2, the condensing unit 3, and the passage between the separating unit 2 and the condensing unit 3 are all kept in the reduced pressure of 5 kPa to 10 kPa.

In the water purifier 100 of the present invention, the targeted water is brought into contact with the nonvolatile compound-containing aqueous solution via the semi-permeable membrane 11 to separate water from the targeted water, and the nonvolatile compound-containing aqueous solution is diluted with the water separated from the targeted water by semi-permeable membrane. These are all performed by the diluting unit 1.

Nest, the diluted nonvolatile compound-containing aqueous solution is heated to separate water vapor from the diluted nonvolatile compound-containing aqueous solution, to thereby obtain the concentrated nonvolatile compound-containing aqueous solution. These are all performed by the separating unit 2.

Then, the separated water vapor is cooled by the condensing unit 3 to generate water.

Part of the generated water is collected as purified water, and the rest of the water is evaporated under the reduced pressure to obtain water vapor. These are performed by the evaporating unit 4. Here, the refrigerant within the cooling pipe is cooled by vaporization heat generated at the time when the water is evaporated, and the cooled refrigerant can be used for air conditioning (cooling air).

The obtained water vapor is absorbed with the concentrated nonvolatile compound-containing aqueous solution obtained in the separating step. This is performed by the absorbing unit 5.

As mentioned above, the water purifier of the present invention can reduce the pressure within the system without any special power, can efficiently obtain highly purified water, and has excellent cooling effects.

Although the water purifier of the present invention is specifically described above, the present invention is not limited to the example above. Various modifications to the example above are acceptable as far as they do not deviate from the concept of the present invention.

The water purifier and water purification method of the present invention can reduce inner pressure of the water purifier without any special power, can efficiently provide highly purified water, and have excellent cooling effects. Therefore, the present invention can be used for purification of various water using conventional absorption cooling systems, and is especially suitably used for purification of sea-water.

What is claimed is:

1. A water purifier comprising:
a diluting unit configured to bring targeted water for purification into contact with a nonvolatile compound-containing aqueous solution via a semi-permeable membrane so as to separate water from the targeted water by the semi-permeable membrane, and to dilute the nonvolatile compound-containing aqueous solution with the separated water;
a separating unit configured to heat the diluted nonvolatile compound-containing aqueous solution so as to separate water vapor from the diluted nonvolatile compound-containing aqueous solution, and to obtain the concentrated nonvolatile compound-containing aqueous solution;
a condensing unit configured to cool the separated water vapor so as to generate water;
an evaporating unit configured to collect, as purified water, part of the water generated by the condensing unit, and to evaporate the rest of the water under the reduced pressure so as to obtain water vapor; and
an absorbing unit configured to allow the concentrated nonvolatile compound-containing aqueous solution obtained by the separating unit to absorb the water vapor obtained by the evaporating unit.

2. The water purifier according to claim 1, wherein the diluting unit is disposed between the separating unit and the absorbing unit, and the nonvolatile compound-containing aqueous solution is circulated between the separating unit and the absorbing unit with a concentration thereof changing.

3. The water purifier according to claim 1, wherein the nonvolatile compound is a compound capable of absorbing water.

4. The water purifier according to claim 1, wherein the nonvolatile compound is a water-soluble compound.

5. The water purifier according to claim 1, wherein the nonvolatile compound is LiBr.

6. The water purifier according to claim 1, wherein the evaporating unit contains a cooling pipe in which a refrigerant is contained and circulated, and
wherein the refrigerant within the cooling pipe is cooled by vaporization heat generated at the time when the water is evaporated in the evaporating unit, and the cooled refrigerant is used for air-conditioning.

7. The water purifier according to claim 1, wherein the evaporating unit, the absorbing unit, and a passage between the evaporating unit and the absorbing unit are all kept in the reduced pressure of 1 kPa or lower.

8. The water purifier according to claim 1, wherein the separating unit, the condensing unit, and a passage between the separating unit and the condensing unit are all kept in the reduced pressure of 5 kPa to 10 kPa.

9. The water purifier according to claim 1, wherein the semi-permeable membrane is a forward osmosis semi-permeable membrane which selectively passes water through.

10. The water purifier according to claim 1, wherein the targeted water for purification is sea-water.

11. A water purification method, comprising:
bringing targeted water for purification into contact with a nonvolatile compound-containing aqueous solution via a semi-permeable membrane so as to separate water from the targeted water by the semi-permeable membrane, and diluting the nonvolatile compound-containing aqueous solution with the separated water;
heating the diluted nonvolatile compound-containing aqueous solution so as to separate water vapor from the diluted nonvolatile compound-containing aqueous solution and to obtain the concentrated nonvolatile compound-containing aqueous solution;
cooling the separated water vapor so as to generate water;
collecting part of the generated water as purified water, and evaporating the rest of the generated water under the reduced pressure so as to obtain water vapor; and
allowing the concentrated nonvolatile compound-containing aqueous solution to absorb the obtained water vapor.
